(19) United States
(12) Patent Application Publication
(10) Pub. No.: US 2003/0053870 A1
(43) Pub. Date: Mar. 20, 2003

(54) Arc-ended cutting tools

(76) Inventors: Clifford M. Flynn, Pittsfield, MA (US); Paul St. Louis, Springfield, MA (US)

Correspondence Address: John G. Posa, Gifford, Krass, Groth, Sprinkle,, Anderson & Citkowski, P.C., 280 N. Old Woodward Ave. Suite 400, Birmingham, MI, 48009-5394, US

(21) Appl. No.: 10/245,193

(22) Filed: Sep. 16, 2002

Related U.S. Application Data
(60) Provisional application No. 60/322,223, filed on Sep. 14, 2001.

(51) Int. Cl. B26D 1/12

(52) U.S. Cl. 407/30

(57) ABSTRACT

In a cutting tool such as an end mill, router bit, tap, thread mill, or other form of insertable rotary tooling, the edge from the center of the tool to the cutting diameter is not a straight line, but instead assumes an arcuate shape. This increases the clearance associated with the center of the tool. In one disclosed example, an arc-ended, ½-inch diameter tool according to the invention starting with a 4-degree dish angle but transitioning to a larger angle of 8 degrees results in a clearance of 0.35, an amount double to the straight-line cut of at 4 degrees, which results in a clearance of 0.0175 drop at center. Broadly, any change in dish angle from lower to higher to increase clearance is anticipated by the invention, including zero degrees to 10 degrees of more, and so forth. Although in the preferred embodiment clearance is increased by a factor of 2 or more, this is not necessary to the invention and, in fact, piecewise linear as opposed to smoothly varying transitions may alternatively be used. This arc end decreases cutting forces in both plunging and ramping operations by directing the cutting forces into a plurality of different directions. This, in turn, reduces the cutting forces and increases feed (RPM) and speed (FEED RATE) in conjunction with material removal. The design also reduces or eliminates chatter, thereby increasing cutting life and utility for the customer in terms of higher throughput and a reduction in tooling cost per part.

### REFERENCE TO RELATED APPLICATION

This application claims priority from U.S. Provisional Patent Application Serial No. 60/322,223, filed Sep. 14, 2001, the entire content of which is incorporated herein by reference.

### FIELD OF THE INVENTION

This invention relates generally to rotary cutting tools and, more particularly, end-mills and other cutting tools which incorporate an arcuate end as opposed to a flat end grind.

### BACKGROUND OF THE INVENTION

Rotary cutting tools are used for various metal machining operations. Such operations are generically referred to as milling operations, and include the forming of slots, keyways, pockets, and the like.

End-mill tools are formed from materials with high hardness, such as tungsten carbide, high-speed steel, polycrystalline diamond (PCD), and other advanced materials. The tool itself typically includes a shank, a body and a cutting head or cutting end having an end cutting face. The shank portion, typically cylindrical, engages with the spindle of a milling machine which, when in use, rotates the end mill about its longitudinal axis. The cutting head is formed at the opposite end of the tool from the shank portion, and typically includes one or more cutting blades, edges, or teeth. The body is that portion of the tool between the shank and the cutting head.

The edges at the cutting head of the tool can be considered to be “flat” cutting edges, to distinguish them from the cutting edges along the body of the tool, which can be considered to be helical or spiral cutting edges, although they can also be straight. The flat cutting edges are known variously as end-cutting edges, face-cutting edges, end-cutting teeth or minor cutting edges. The angle between a plane perpendicular to the longitudinal end mill axis and the end cutting edge is known as the dish angle, but is also called “base-cutting edge angle,” “minor cutting edge angle,” or “end cutting edge angle.” Such a geometry results in the center of the end face being slightly deeper (dished) than the other periphery of the tool.

The prior art teaches end-cutting edges that are straight in the plane passing through the longitudinal axis of the tool, including dish angles ranging from 0 up to 10 degrees, but ordinarily between 2 and 3 degrees. Beck, U.S. Pat. No. 5,049,009, discloses a dish angle ranging from 0.25 to 1.5 degrees which, according to this reference, greatly reduces chipping of end cutting teeth and reduce corner wear. Jewett, Sr., et al., U.S. Pat. No. 4,597,226, discloses an apparatus for sharpening end mills, the end mills having a dish angle with value between 0 and 3 degrees. Kirby, U.S. Pat. No. 5,213,452, discloses a router-type cutter with end teeth that have chamfers with 2 degree dish angles.

Maharidge, U.S. Pat. No. 4,134,235, discloses a grinding apparatus for end mill cutters, the apparatus capable of providing the desired dish angle, usually between 0 and 3 degrees, to the end teeth. Tsujimura, et al., U.S. Pat. No. 4,966,500, discloses a facing milling cutter with cutter inserts, a first cutter insert having a dish angle ranging from 1 to 10 degrees, and the other cutting inserts having dish angles ranging from −1 to +1 degrees. Cross, U.S. Pat. No. 4,341,044, discloses a machine for grinding end gashes in end mill cutters, the machine establishing the end cutting teeth of the end mill by dishing the end face of a cylindrical bar about 1 to 3 degrees, so that the center of its end face is slightly deeper than the periphery. Gase, U.S. Pat. No. 2,129,418 discloses a milling tool having short end-cutting blades on the end face of the tool and a depression of conical or arcuate shape starting from the ends of the cutting edges, the purpose of the depression being to guide chips away without clogging the cutting end.

### SUMMARY OF THE INVENTION

Broadly according to this invention, the edge from the center of a tool such as an end mill to the cutting diameter is not a straight line, but rather, is arcuate in shape. Overall, this arc-ended design acts to increase the strength of the tool geometry. In contrast to existing designs, this arc end decreases cutting forces in both plugging and ramping operations by directing the cutting forces into a plurality of different directions, thereby reducing the cutting forces of a straight line found in a conventional end grind of the type now used in standard end mills.

The benefit of this new design facilitates a higher feed (RPM) and/or speed (FEED RATE) in conjunction with material removal. The design also reduces or eliminates chatter, thereby increasing cutting life and utility for the customer in terms of higher throughput and a reduction in tooling cost per part.

### BRIEF DESCRIPTION OF THE DRAWINGS

FIG. 1 is a drawing of a tool incorporating a conventional end grind, resulting in cutting forces oriented in substantially the same direction;

FIG. 2 is a drawing which shows a conventional tool and the clearance associated therewith;

FIG. 3 is a drawing which shows an arc-ended design according to the invention, and the way in which cutting forces are oriented into a plurality of different directions; and

FIG. 4 is a drawing which shows the way in which clearance of the center of the tool is increased by virtue of the instant invention.

### DETAILED DESCRIPTION OF THE INVENTION

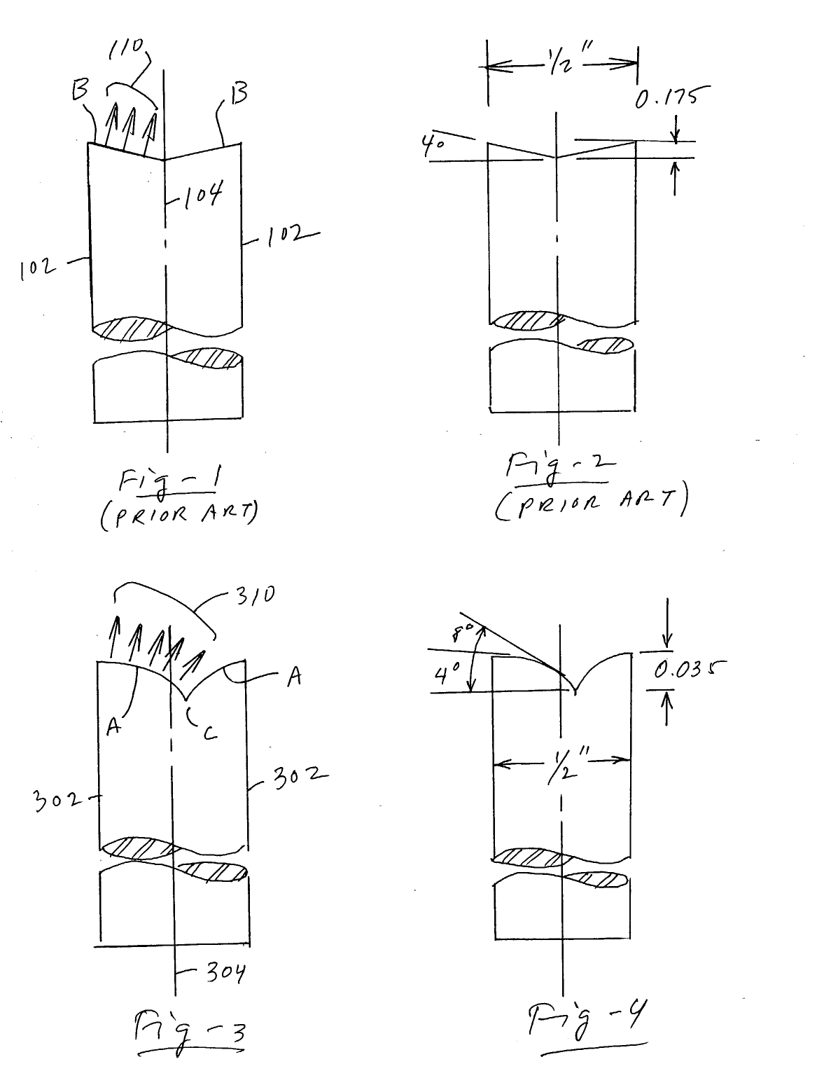

Reference is now made to the drawings, wherein FIG. 1 is a simplified view of an existing tool such as an end mill, including a conventional end surface grind in the form of a straight line represented by surface B. Regardless of the number of cutting surfaces (i.e., two or more), each end cutting edge extends from the outer surface of the tool 102 to the centerline 104, resulting in cutting forces 110 substantially transverse to the surfaces B. Such a design yields restricted clearance 120 near the center of the tool, interfering with chip removal and heat transfer.

FIG. 2 is a drawing which is more specific to the clearance associated with a conventional tool. As an example, a standard ‘dish angle’ of 4 degrees on a ½-inch diameter tool results in a clearance drop of 0.0175 at center. Such a shallow clearance may lead to problems identified above in conjunction with chip removal and thermal transfer.

FIG. 3 is a drawing which shows a preferred embodiment according to the invention, wherein, as opposed to straight edges from the outward surface of the tool 302, the ends include one or more arcuate surfaces “A.” The design of this style of cutting tool directs the cutting forces 310 in multiple different directions, thereby enhancing the ability of the tool in plunging, drilling and ramping operations. Note, further, that the arcs terminate in a point C which is offset from the center line of the tool 304 in the preferred embodiment to ensure that the tip effectively wipes the surface of the workpiece.

FIG. 4 is a drawing which shows the way in which clearance of the center of the tool is increased by virtue of the instant invention. For example, an arc-ended tool according to the invention starting with the same 4-degree angle but transitioning to a larger angle of 8 degrees results in a clearance of 0.35, an amount double to the straight-line cut of FIG. 2 and a clearance of 0.0175 drop at center. Although this specific example shows a transitions from 4 degree to 8 degrees, any change in dish angle from lower to higher to increase clearance is anticipated by the invention, including zero degrees to 10 degrees of more, and so forth. Although in the preferred embodiment clearance is increased by a factor of 2 or more, this is not necessary to the invention and, in fact, piecewise linear as opposed to smoothly varying transitions may alternatively be used.

Benefits of the invention include increased feeds (RPM), and speed (FEED RATE) in ramping, plunging and drilling operations, as well as a reduction or elimination of chatter in such operations, thereby increasing tool life, whether composed of carbide or other materials. Thus, although the invention is well suited to end mills, it is also applicable to other types of cutting tools, including router bits, taps, thread mills, and insertable helical tooling.

Removal of heat and chips from the work zone increases tool life, while improving part finish from the wiping action of the arc and the geometries, thereby increasing effectiveness for the customer in faster throughput and a reduction in tooling cost per part. The invention further improves product surface finish, made possible by chip clearance, improvement in heat transfer removal from the center of the tool.

We claim:

1. A cutting tool, comprising:
a body having a center and terminating in a cutting end with one or more cutting edges; and
wherein at least one of the edges begins at a first dish angle and transitions to a second dish angle which is greater than the first to increase the clearance at the center of the tool.

2. The cutting tool of claim 1, wherein the transition from the first dish angle to the second dish angle results in a clearance of two or more compared to a tool incorporating the first dish angle and no transition.

3. The cutting tool of claim 1, wherein the first dish angle is two degrees or less.

4. The cutting tool of claim 1, wherein the second dish angle is four degrees or more.

5. The cutting tool of claim 1, wherein the transition from the first dish angle to the second dish angle forms a continuous arc.

6. The cutting tool of claim 1, wherein the transition from the first dish angle to the second dish angle is piecewise linear.

7. The cutting tool of claim 1, wherein the cutting edge including the transition extends from the outer surface of the body to a point offset from the center of the tool.

8. The cutting tool of claim 1, wherein the body and cutting edges are associated with an end mill.
